(19) United States
(12) Patent Application Publication
(10) Pub. No.: US 2009/0206590 A1
(43) Pub. Date: Aug. 20, 2009

(54) FOAM BOOK WITH IMPROVED BINDING AND REMOVABLY INSERTABLE INTERIOR BOOK

(76) Inventor: Melanie Gerth, Prosper, TX (US)

Correspondence Address: HUSCH BLACKWELL SANDERS LLP, 720 OLIVE STREET, SUITE 2400, ST. LOUIS, MO, 63101, US

(21) Appl. No.: 12/032,452

(22) Filed: Feb. 15, 2008

(51) Int. Cl. B42D 1/00

(52) U.S. Cl. 281/21.1

(57) ABSTRACT

A book with improved binding including a front cover page and a back cover page constructed of a non-foam material, at least one center page constructed substantially of a foam material, at least one external binding sheet and at least one internal binding sheet for binding the front and rear cover pages and the at least one center page in book format. In one embodiment, the external binding sheet attaches to at least a portion of one side of the first and last center pages and wraps around both sides of the front and back cover pages. In another embodiment, the external binding sheet attaches to a portion of one side of the front and back cover pages and wraps around to the other side of the front and back cover pages. In still another embodiment, the external binding sheet attaches to at least a portion of one side of the front and back cover pages. Internal binding sheets bind the remaining pages in book format. At least one center page may include an opening or recess adapted for receiving a removably insertable interior book for enhancing the storyline or developing a sub-theme with respect to the characters or things described within the book.

### BACKGROUND OF THE INVENTION

The present invention relates generally to foam type books for children and, more particularly, to both a foam book with improved bindings for improving the durability of the book and, to a foam book with a removably insertable interior book associated with at least one of the book pages. In one embodiment, the present invention relates to a book with at least one center page comprised of foam, a front and back cover page comprised of a material other than foam, and a plurality of different binding configurations including wrapping an external binding sheet around the front edge portion of both the front and back cover pages. In another embodiment, the present invention relates to a foam book wherein at least one center page includes a cut-out sized and shaped to receive a removably insertable interior book, the foam book being adapted to fully open and close when the at least one interior book is inserted therewithin.

Books of all types have existed for thousands of years. Manufacturers of such books are constantly searching for new and better materials for both making and forming the front and back covers and interior pages of these books, and for improved methods of binding the same in book format. More recently, children's books have been constructed of foam. See for example, the foam book disclosed in U.S. Pat. No. 7,144,044. For children, this foam construction is safer and more durable than paper and other non-foam materials, and such foam construction has the added benefit of being waterproof and buoyant. The foam pages associated with these books are sometimes bound together with an additional, thinner piece of foam which extends across the back edges of the individual pages of such books and overlaps a portion of the front and back cover pages, acting as a spine.

Another method of binding foam pages in a foam book is disclosed in U.S. Pat. No. 6,390,507. In this prior art binding method, binding sheets roughly twice the width of a foam page are used to bind consecutive pages to one another such that a page is not bound to a central spine, but instead, is bound only to adjacent pages. These binding sheets may extend all the way to the peripheral edge portion of the foam pages, or they may extend to a position short of the page edge portions leaving only the thick edges of the foam pages showing when the book is closed.

Thick foam pages have, themselves, been used to enhance the desirability of such books. For example, U.S. Pat. No. 6,189,932 and its parent patent U.S. Pat. No. 6,070,909 both teach the construction of a book in which a portion of a foam page is cut-out thereby leaving an analogously shaped hole in the page. The cut-out piece or “manipulative” may be imprinted with indicia in accordance with the theme of the book and such cut-out piece is then reinserted within its page hole such that the cut-out piece can be removed from such page and played with by a child. In certain cases, the interior of the page hole may likewise include indicia in accordance with the theme of the book. Once finished with play, the cut-out piece is reinserted into its page hole for storage and use at a later date.

U.S. Pat. Nos. 6,189,932 and 6,071,909 also disclose that the cut-out pieces or manipulatives may be of varying thickness, and may also be shaped as puzzle pieces so as to fit together with each other in a puzzle-like fashion outside of the book. In another embodiment, the cut-out pieces or manipulatives are cooperatively engageable with an interlocking flat stand which is likewise housed in an analogously shaped hole associated with one of the pages of the book. In this regard, the interlocking base of the manipulative is snap-fitted into a cooperative opening associated with the flat stand so as to provide a substantially perpendicular profile of the manipulative in relation to the interlocking flat stand. Also, since the manipulatives and interlocking flat stand are made of a foam material, these prior art patents contemplate that the manipulatives and other components of the book made of foam will, when wet, stick to bathroom surfaces such as bathtubs, shower walls, and the like and that these manipulatives will float in water. Although these manipulatives have some utility for infants and toddlers, they are one dimensional in the sense that they represent a single sheet of foam material having opposed front and back surfaces and typically provide only one surface face with indicia. This provides limited utility to older children.

It is therefore desirable to provide a children's book with improved binding configurations so as to improve the durability and integrity of the overall book throughout its useful life, and to provide a book which includes one or more removably insertable interior books which are removably received within a corresponding recess associated with an interior page, the interior book providing greater functionality as compared to the known manipulatives, and which interior book can present a storyline, sub-theme or related theme tied to the overall theme of the book.

### SUMMARY OF THE INVENTION

The present invention overcomes many of the shortcomings and limitations of the prior art foam books discussed above and teaches the construction and operation of several embodiments of a foam book with improved bindings and a foam book with at least one removably insertable interior book associated therewith. The present binding methods improve the overall strength, rigidity, durability and longevity of the present books, and the present removably insertable interior book feature adds additional storylines, themes, and informational material to a reader thereby greatly increasing the use and enjoyment of such books by children and other readers.

In one aspect of the present invention, a children's book is provided which includes a front cover page constructed of a non-foam material, a back cover constructed of a non-foam material, one or more center pages constructed substantially of a foam material, at least one exterior binding sheet and at least one interior binding sheet, the exterior and interior binding sheets being attached to the various front, back and center pages of the present book in various configurations to improve the binding thereof. In one embodiment, the at least one external binding sheet is attached to at least a portion of one side of the front and back cover pages and wraps around to the other side of the front and back cover pages, the at least one internal binding sheet is attached to one side of the front cover page and to one side of the adjacent first center page, another internal binding sheet is attached to the respective sides of any remaining interior center pages, and another binding sheet is attached to one side of the back cover page and one side of the adjacent last center page.

In another embodiment, the at least one external binding sheet is attached to one side of the first and last interior center pages as well as to both sides of the front and back cover pages, and internal binding sheets are used to attach any remaining interior center pages to each other in book format.

In still another embodiment, the at least one exterior binding sheet is attached only to the outside portion of both the front and back cover pages and internal binding sheets are utilized to attach all remaining adjacent center pages including attaching the inside portion of the front and back cover pages to the respective adjacent first and last center page.

In some embodiments, the external binding sheet binds the front and back cover pages to the first and last interior center pages, and in other embodiments it only binds the front and back cover pages together.

In all of the various embodiments, the external binding sheet forms a spine for the book that allows the book to open and close in book format. Internal binding sheets are provided, where needed, to bind respective adjacent pairs of center pages, and in some embodiments, to bind the inside portion of the front and back cover pages to the respective first and last center pages. Any type of foam material suitable for use by children may be utilized for the manufacture of the respective center pages, and any suitable non-foam material such as paper or various forms of board material may be utilized in the manufacture of front and rear cover pages.

In another embodiment, the front and back cover pages are formed solely from the external binding sheet and no additional material such as a board material is utilized in the fabrication thereof. In this regard, the external binding sheet is typically folded over onto itself to form the inside and outside portions of the respective front and back cover pages and such external binding sheet is then attached to the other pages of the present book according to the various binding methods disclosed above.

In still another embodiment, at least one center page includes an opening or recess adaptable for removably receiving an interior book sized and shaped for insertion therewithin. The interior book includes a front page and a back page and will typically develop an additional storyline or sub-theme associated with some of the characters or other things described and/or associated with the overall book. This interior book is sized and shaped so as to be removably insertable within the opening or recess associated with a particular center page and can be made out of any suitable material including foam. This “book inside a book” feature adds additional functionality to the present book as compared to simple cut-out “manipulatives” as disclosed in the prior art, and such feature provides more storyline, information and/or material to the present book for more enjoyment by its readers. This removably insertable interior book can be associated with any interior center page of a particular book, including positioning and locating multiple interior books on the same side of a particular center page, positioning and locating at least one interior book on each opposite side of the same center page, or positioning and locating at least one interior book on facing sides of adjacent center pages.

In addition, the front and back cover pages may take on any shape suitable for binding in book format including a sculptured or non-rectangular shape, and the present book may include an opening extending through all of the pages thereof including the front and rear cover pages so as to form a handle for carrying the book. Still further, the front cover page may also include an opening which extends therethrough which provides visual access to at least a portion of the first center page located therebehind, or to a portion of an interior book located within the first center page.

### BRIEF DESCRIPTION OF THE DRAWINGS

For a better understanding of the various embodiments of the present invention, reference may be made to the accompanying drawings, wherein like numbers refer to like or similar parts and/or construction.

FIG. 1 is a perspective view of one embodiment of a foam book constructed in accordance with the teachings of the present invention wherein the front and back cover pages are made of a non-foam material, the center pages are made of a foam material, and a plurality of binding sheets connect the various pages in book format.

FIG. 2A is a top plan view of the book of FIG. 1 showing one of the present binding configurations wherein the external binding sheet wraps around the front edge portion of both the front and back cover pages.

FIG. 2B is a top plan, view of another embodiment of a foam book constructed in accordance with the teachings of the present invention wherein the pages are formed by the external non-foam binding sheets.

FIG. 3 is a perspective view of still another embodiment of a foam book constructed in accordance with the teachings of the present invention wherein binding sheets bind foam center pages and non-foam front and back cover pages, and at least one center page includes at least one removably insertable interior book.

FIG. 4 is an exploded perspective view of the foam book of FIG. 3 showing the removably insertable interior book removed from its associated center page.

FIG. 5 is a perspective view of one embodiment of the removably insertable interior book.

FIG. 6 is a perspective view of another embodiment of the removably insertable interior book.

FIG. 7A is a front elevational view of another embodiment of a book constructed in accordance with the teachings of the present invention within the front cover page is of a non-rectangular shape.

FIG. 7B is a front elevational view of the book of FIG. 7A shown in open book form.

FIG. 8A is a front elevational view of still another embodiment of a book wherein the front cover page is rectangular in shape.

FIG. 8B is a front elevational view of the book of FIG. 8A shown in open book form.

### DETAILED DESCRIPTION

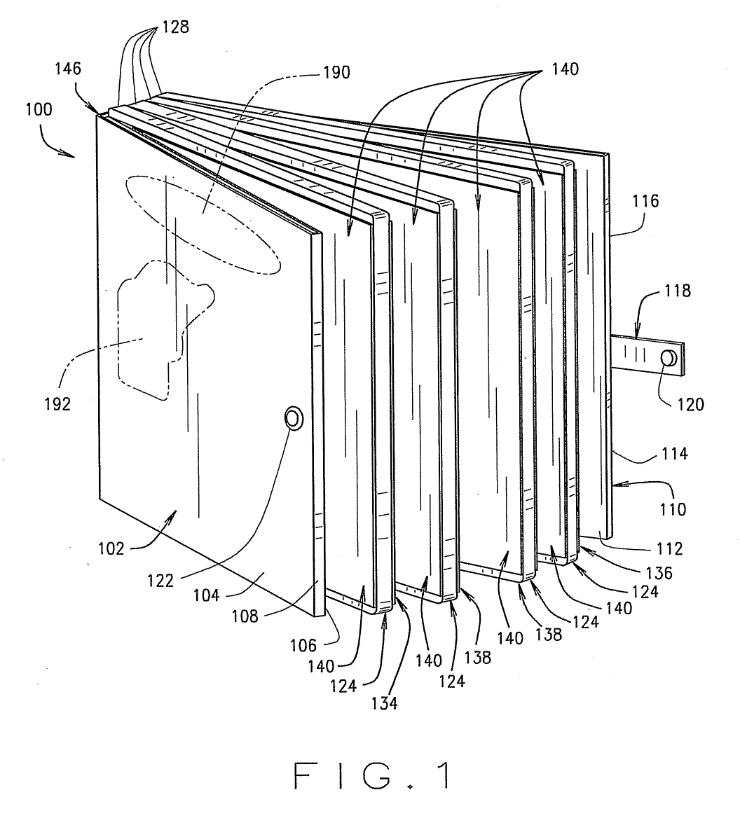

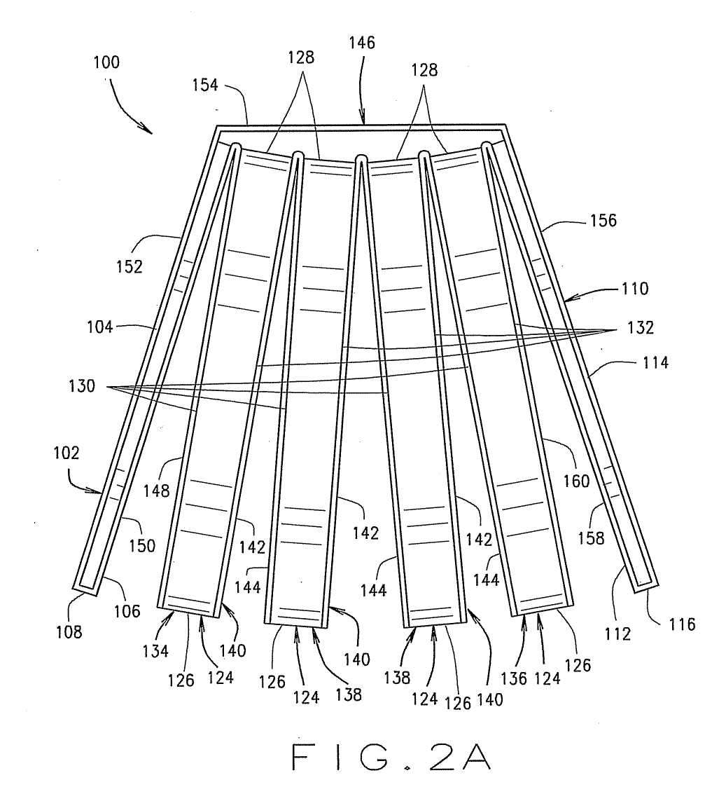

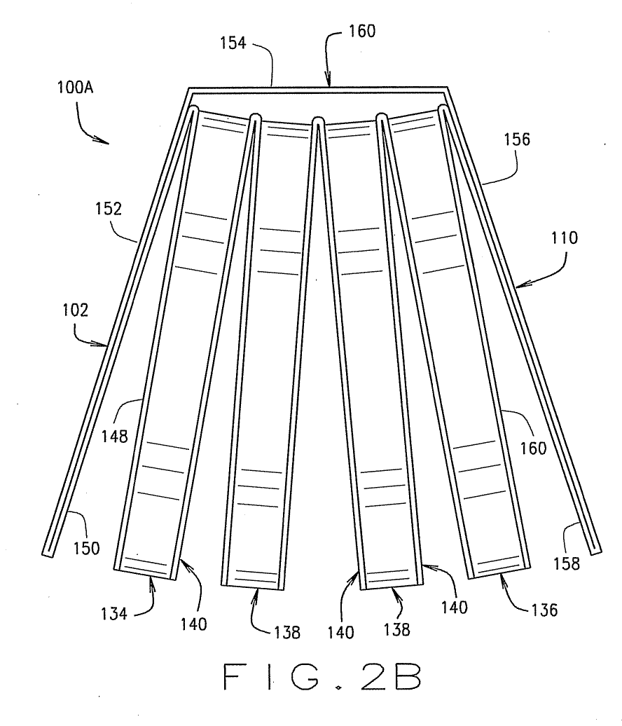

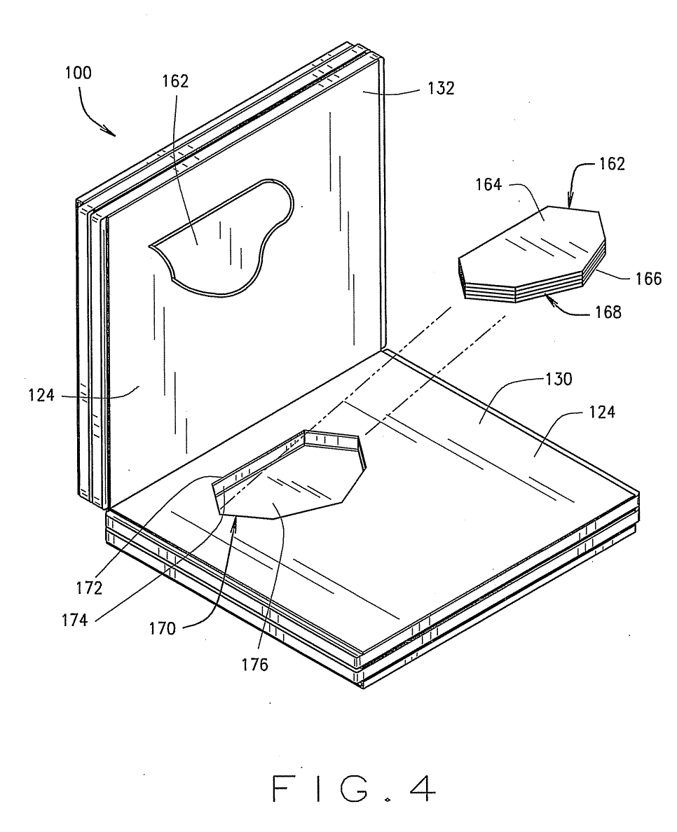

Several embodiments of the present invention are illustrated in FIGS. 1-8. Referring to the drawings more particularly by reference numbers, wherein like numerals refer to like parts, the number 100 in FIGS. 1 and 2A identify one embodiment of a children's book constructed in accordance with the teachings of the present invention. Book 100 includes a front cover page 102 having an outside portion 104, an opposed inside portion 106 and a leading edge portion 108, and a back cover page 110 having an inside portion 112, an opposed outside portion 114 and a leading edge portion 116. Both the front and back cover pages 102, 110 are constructed of a non-foam material, which provides strength, stability, rigidity and durability to the overall book 100. Any suitable non-foam material such as a wide variety of different types and thicknesses of paper, clipboard, other board materials, and still other non-foam materials may be used in the fabrication of the front and back cover pages 102 and 110. FIG. 1 shows an optional book closing flap 118 which may be associated with the back cover page 110, the book closing flap 118 including a first latch piece 120 which selectively and cooperatively couples to a corresponding second latch piece 122 associated with the front cover page 102. The book closing flap 118 and latch pieces 120, 122 selectively secure the front and back covers pages 102, 110 to one another in a closed position, thereby securing the entire book 100 in a closed position.

As best shown in FIGS. 2A and 2B, at least one center page 124 is provided and is preferably comprised substantially of foam, where each center page 124 includes a leading edge portion 126, a rear edge portion 128, and opposed front and back sides 130 and 132 respectively. Where at least two center pages 124 are present in a book, the center page 124 located adjacent to the front cover page. 102 will be referred to herein as the first center page 134, while the center page 124 located adjacent to the back cover page 110 will be referred to herein as the last center page 136. Where three or more center pages 124 are present in a book as shown in FIGS. 2A and 2B, the center pages 124 located between the first and last center pages 134 and 136 will be referred to herein as middle or interior center pages 138. All of the center pages 124, 134 and 136 may be constructed of any suitable foam material in any size and thickness known to those skilled in the art such as a polymeric ethyl vinyl acetate (EVA) material so long as such foam material is suitable for the particular application such as durability, usability and printability.

A middle center page 138 is bound to a neighboring or adjacent center page 124, 136 or 138 by an internal binding sheet 140 having a first section 142 and a second section 144. The first section 142 of the internal binding sheet 140 is preferably attached to at least a portion of the back side 132 of one center page 124 and the second section 144 of the same internal binding sheet 140 is preferably attached to at least a portion of the front side 130 of the next adjacent center page. These internal binding sheets 140 reside between each center page and an adjacent center page and such binding sheets 140 may be attached to any portion of the respective sides thereof. It is further recognized and anticipated that the internal binding sheets 140 are attached to their respective center pages 124, 136 and/or 138 so as to bind them together and allow for proper opening and closing of the center pages. The internal binding sheet 140 may extend along the respective sides of its respective center pages 124 such that a perimeter of each of the center pages 124 extends beyond the internal binding sheet 140, or the binding sheet 140 may extend to completely cover the respective sides 130, 132 of the center pages 124. An internal binding sheet 140 is preferably roughly twice the width of a center page 124, extending to or slightly short of the leading edge portion 126 thereof, although an internal binding sheet 124 may optionally be any width and/or length so long as the first section 142 thereof is attached to at least a portion of one side a center page 124 and the second section 144 thereof is attached to at least a portion of one side of the next center page 140 thereby binding two consecutive center pages 124 to each other for opening and closing in book fashion.

As best shown in FIG. 2A, an external binding sheet 146 preferably includes first through seventh portions 148, 150, 152, 154, 156, 158, 160 which, in one embodiment, are contiguous. The first portion 148 of the external binding sheet 146 is affixed to the front side 130 of the first center page 134 adjacent the leading edge portion 126 thereof and extends to the rear edge portion 128. The second portion 150 of the external binding sheet 146 is affixed to the inside portion 106 of front cover page 102 and extends to and wraps around the leading edge portion 108 of the front cover page 102. The third portion 152 of the external binding sheet 146 is affixed to the outside portion 104 of the front cover page 102 and extends completely across cover portion 104 to the rear of the book as shown in FIG. 2A. The fourth portion 154 of the external binding sheet 146 then wraps around the rear edge portions 128 of the center pages 124 and, in the embodiment illustrated, the external binding sheet 154 portion is not affixed to or otherwise contracts the rear edge portions of the center pages 128, nor is it affixed to the rear edge portions of the front and rear cover pages 102 and 110. In this regard, it is recognized and anticipated that the external binding sheet 154 may optionally be affixed to some or all of these rear edge portions 128, or to one or both of the rear edge portions of the front and rear cover pages 102 and 110. The fifth portion 156 of the external binding sheet 146 is then wrapped around to and affixed to the outside portion 114 of the back cover page 110 from the rear of the book, the external binding sheet portion 156 extending completely across the back cover outside portion 114 to the leading edge portion 116. The external binding sheet 146 then wraps around the leading edge portion 116 of back cover page 110 and the sixth external binding sheet portion 158 extends across and is affixed to the inside portion 112 of the back cover page 110. The seventh portion 160 of the external binding sheet 146 then wraps around and is affixed to the back side portion 132 of the last center page 136 extending from its rear edge portion 128 to its leading edge portion 126 as illustrated in FIG. 2A. If the book 100 has only one center page 124, both the first and seventh portions 148 and 160 of the external binding sheet 146 are preferably attached to the respective sides of the one center page 124. In this particular embodiment, one external binding sheet 146 is used to bind both opposed side portions of the front and rear cover pages 102 and 110 to one side of the first and last center pages 134 and 136 in book format. Other embodiments are also possible as will be hereinafter disclosed. This arrangement, including wrapping the external binding sheet 146 around the leading edge portions of both the front and back cover pages, adds improved strength and rigidity to the overall book structure and improves durability. It is also recognized and anticipated that the external binding sheet 146 may include several binding sheets connected together or otherwise joined together to function as the external binding sheet 146 described above.

The external binding sheet 146, which may be a single sheet or several sheets, may extend along the one side of the first and last center pages 134 and 136 and along the opposed sides of the front and back covers pages 102 and 110 such that a foam perimeter of the first and last center pages 134, 136 and a non-foam perimeter of the front and back cover pages 102, 110 extends beyond the external binding sheet 146. The external binding sheet 146 may also be sized to completely cover the center pages 134 and 136 and front and back cover pages 102 and 110, or the various portions of the external binding sheet 146 may extend across and cover any portion of each of the respective front and back cover pages 102, 110 and first and last center pages 134, 136 as described above. The external binding sheet 146 binds the front and back covers pages 102, 110 together, and the front cover page 102 to the first center page 134, and the back cover page 110 to the last center page 136 in book format.

In another embodiment, the external binding sheet 146 may not include the first or seventh portions 148 and 160 such that it does not bind the front cover page 102 to the first center page 134, or back cover page 110 to the last center page 136. Instead, in this particular embodiment, the external binding sheet 146 would only include the second through sixth portions 150, 152, 154, 156 and 158 and would wrap around the front and back cover pages 102 and 110 as previously explained. In still another embodiment, the external binding sheet 146 may not include the first, second, sixth or seventh portions 148, 150, 158, 160, such that it does not wrap around the leading edge portions 108 and 116 of the front and back cover pages 102, 110, and it does not bind the front cover page 102 to the first center page 134, or the back cover page 110 to the last center page 136. Instead, in this embodiment, the external binding sheet 146 would only attach the outside portions 104 and 114 of the front and back cover pages as previously explained. In these embodiments, an internal binding sheet 140 would serve to bind the inside portion 106 of the front cover page 102 to the first center page 134, and another internal binding sheet 140 would serve to bind the inside portion 112 of the back cover page 110 to the last center page 136, as additional internal binding sheets 140 would bind adjacent interior center pages 124 described above.

In an alternative embodiment of the book 10A, illustrated in FIG. 2B, the front and back cover pages 102 and 110 are formed solely from the external,binding sheet 146, namely, from the second and third portions 150 and 152 and from the fifth and sixth portions 156 and 158 of the external binding sheer 146 respectively. In the embodiment of FIG. 2B, the first and seventh portions 148 and 160 of the external binding sheet 146 are attached directly to the first and last center pages 134 and 136 respectively, as previously explained with respect to the book 100 of FIG. 2A, and the external binding sheet portions 150, 152 and 156, 158 are folded upon themselves as illustrated to form the front and back cover pages 102 110. In another embodiment, external binding sheet portions 148 and 160 may be eliminated and an internal binding sheet 140 may be used to bind the first center page 134 to the external binding sheet portion 150 as well as to bind the last center page 136 to the external binding sheet portion 158. Middle center pages 138 are attached to each other using additional internal binding sheets 140 as previously explained.

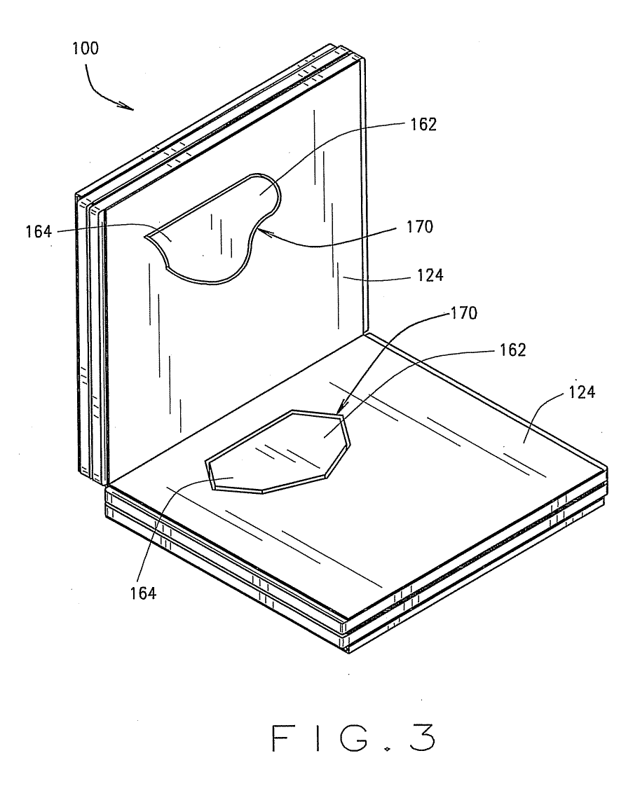

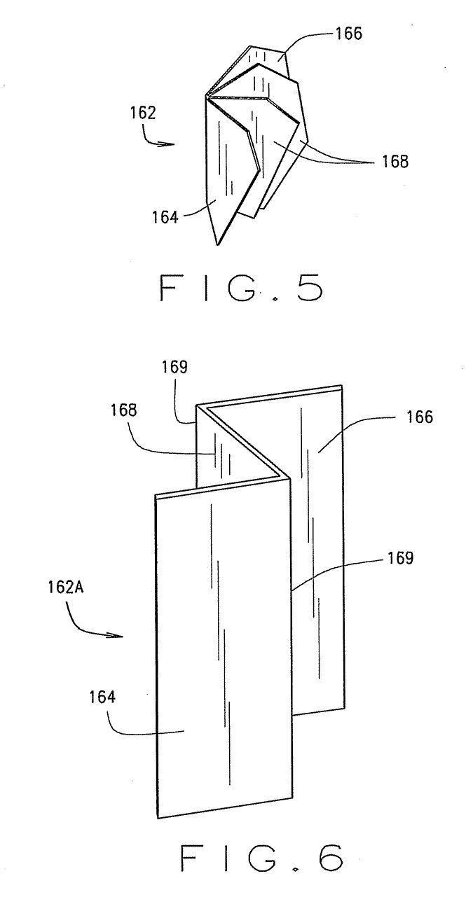

As shown in FIGS. 3-6, at least one center page 124 houses an interior book 162 which includes at least a front page 164 and a back page 166 (FIG. 5). The interior book 162 may be shaped and themed to coincide with the story of the book 100. FIGS. 3-5 show the front and back pages 164, 166, along with interior pages 168, of the interior book 162 bound together in book format. It is also recognized and anticipated that the interior book 162 need not be bound in book format, but may be folded or bound accordion-style, as shown by the interior book 162A in FIG. 6. In this embodiment, the front and back cover pages 164, 166 of the interior book 162 may be formed by folding a single sheet of material along a fold line such as fold lines 169 such that a fold line acts as a spine and delineates the front and back pages 164, 166. The interior book 162 is adapted for removable insertion into a suitably sized and shaped cut-out section 170 of a center page 124 which cut-out section, or recess 170 is sized, shaped and adapted to accept the interior book 162 therein while still allowing the center pages 124 to properly open and close in book format. The interior book 162 may be any size and shape that allows for the connection of its various front, back and interior pages in some type of book or brochure or pamphlet format. The interior book 162 may also be any size and shape adaptable to being removably inserted into a correspondingly shaped recess 170 associated with one or more center pages 124. The interior book 162 may be constructed of foam, board, paper, or any other material suitable for use in producing an interior book constructed in accordance with the teachings of the present invention.

A cut-out section 170 may be located on either the front or back side 130 and 132 of a center page 124, or one may be located on both sides 130, 132 of a center page 124, each cut-out section 170 being adapted to receive an interior book 162. Multiple cut-out sections 170 may also be located on the same side of the same center page 124 such that multiple interior books 162 may be housed within a single center page 124. Still further, the cut-out sections 170 may also be located on facing sides of adjacent center pages, i.e. the back side 132 of one center page 124 and the front side 130 of the next adjacent center page 124. The cut-out section 170 is a cavity, recess or opening formed in a center page 124 by removing a suitably sized and shaped section or portion of both the foam center page 124 and the binding sheet overlaying that side of the center page such as any one of the binding sheets 142, 144, 148 and 160, possibly by die-cutting, such that the position and shape of the cavity in the center page 124 corresponds with the position and shape of the hole in the corresponding internal binding sheet. The recess 170 is shaped and sized for removably receiving an associated interior book 162 such that the book 100 and center pages 124 are adapted to properly open and close in book format when the interior book 162 is inserted within the recess 170 in a center page 124. Preferably, the recess 170 is similarly sized and shaped as its associated interior book 162 such that its perimeter corresponds to the perimeter of the internal book 162 positionable therein, and its depth corresponds to the depth of the internal book 162. Nevertheless, a cut-out section 170 need only be sized and shaped to accept its corresponding internal book 162. Thus, internal binding sheet 140, or another appropriate binding sheet, forms a first shoulder forming member 172 and the center page 124 forms a second shoulder forming member 174, preferably both of which abut the perimeter of the internal book 162 along at least a portion thereof with sufficient frictional or other force to retain the interior book 162 in place until a user removes the interior book 162 from the recess 170.

The recess 170 may optionally extend completely through the center page 124, but not through the binding sheet associated with the opposite side thereof. In this embodiment, the bottom wall portion 176 of recess 170 is formed by the binding sheet. It is also recognized that recess 170 may optionally extend completely through both the center page 124 and the binding sheets on each opposite side thereof. Where the cut-out section 170 does not pass completely through the center page 124, bottom wall portion 176 is formed by the remaining, non-cut portion of the center page 124.

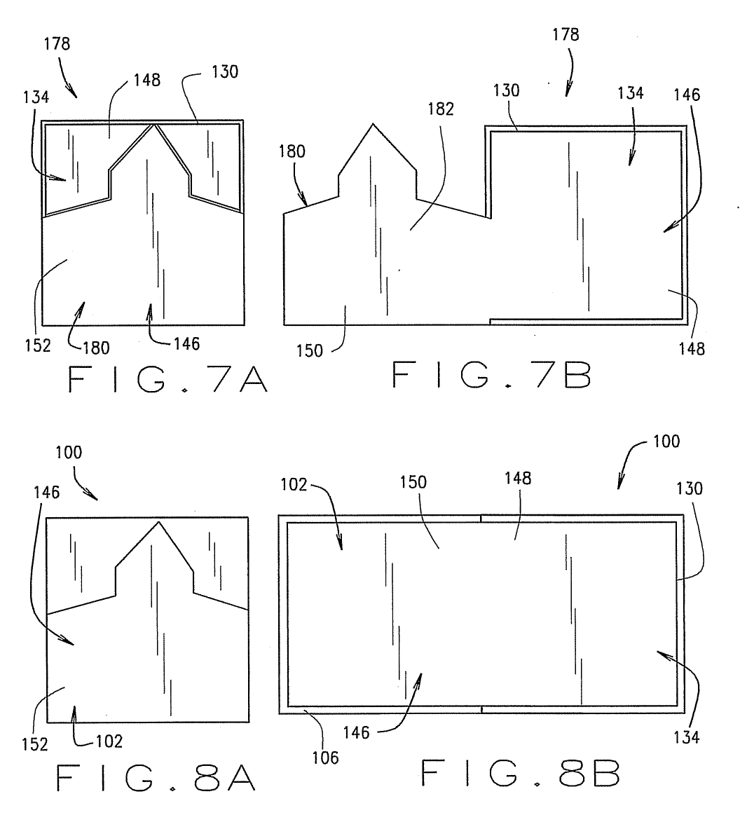

The front and back cover pages 102, 110 may take on any shape suitable for binding in book format such as a shape which coincides with some aspect of the storyline or theme of the book 100. FIGS. 7A and 7B illustrate a book 178 which includes a non-rectangularly shaped cover page 180. FIG. 7A shows the book 178 in its closed condition and FIG. 7B shows the book 178 opened to its first interior page. This non-rectangularly shaped front cover page allows part of the first center page 134 to be seen even with the cover page 180 closed. Visible in FIG. 7A is the perimeter of the non-rectangularly shaped cover page 180 and the third portion 152 of the external binding sheet 146, as well as the perimeter of the front side 130 of the first center page 134 and its corresponding external binding sheet portion 148. Visible in FIG. 7B are the first and second portions 148, 150 of the external binding sheet 146 and the perimeter of the front side 130 of the first center page 134 and the inside portion 182 of the front cover page 180. Center pages 124 may also be any suitable shape for binding.

Alternatively, FIGS. 8A and 8B illustrate the book 100 with a front cover page 102 as shown in FIGS. 1-4 wherein the cover page 102 is rectangular in shape and any indicia associated therewith is merely imprinted thereon. FIG. 8A again shows the book 100 in its closed condition and FIG. 8B shows the book 100 opened to its first interior page. FIG. 8A illustrates the book 100 with the cover 102 closed. Visible in FIG. 8A are the front cover page 102 and the third portion 152 of the external binding sheet 146. Visible in FIG. 8B are the perimeter of the inside portion 106 of the front cover page 102 and the perimeter of the front cover page 102 and the perimeter of the front side 130 of the first center page 134 and the corresponding first and second portions 148 and 150 of the external binding sheet 146.

As seen in FIG. 1, the book 100 may additionally have an opening 190 extending through the front cover page 102, the back cover page 110, and the center pages 124, such that the opening 190 forms a handle for carrying the book 100. The front cover page 102 may also include an opening 192 which extends therethrough, the opening 192 providing visual access to at least a portion of the first center page 134 or to a portion of an interior book 162 located within the first center page 134.

One or more embodiments of the present invention allow for the use and enjoyment of an interior book 162 inside of a book 100 with foam center pages 124 and non-foam front and back cover pages 102 and 110. As the interior book 162 can be sized and shaped for countless designs and applications, the possibilities for its use are much broader than those for a simple cut-out foam “manipulative” as disclosed in the prior art. For example, the interior book 162 may be designed to embellish the storyline or theme of the book, or to develop a sub-theme or additional storyline associated with the characters or things described in the book itself The interior book 162 can be removed from the book 100 and read separately to discover more about that specific character or thing that is discussed in the book 100. Thus, this “book inside a book” feature is more instructional, it provides more storyline; information and/or material to the reader; and it is more enjoyable for readers.

As is evident from the foregoing description, certain aspects of the present invention are not limited by the particular details of the examples and drawings illustrated herein, and it is therefore contemplated that still other modifications and applications, or equivalents thereof, will occur to those skilled in the art.

Thus, there has been shown and described several embodiments of a novel book assembly which is adaptable for use by children and other readers. Many changes, modifications, variations and other uses and applications of the present invention will, however, become apparent to those skilled in the art after considering this specification and the accompanying drawings. All such modifications, variations and other uses in applications which do not depart from the spirit and scope from the present invention are deemed to be covered by the present invention which is limited only by the claims which follow.

What is claimed is:

1. A book comprising:
a front cover page having opposed sides and constructed of a non-foam material;
a back cover page having opposed sides and constructed of a non-foam material;
at least one center page having opposed sides and constructed substantially of a foam material;
at least one binding sheet connecting the front and back cover pages and the at least one center page in book format.

2. The book of claim 1 wherein said at least one binding sheet is attached to one side of said at least one center page, both sides of said front and back cover pages, and the opposite side of said at least one center page.

3. The book of claim 1 wherein said at least one binding sheet includes at least an external binding sheet and at least one internal binding sheet, and wherein said at least one center page includes at least two center pages, said external binding sheet being attached to one side of one of said at least two center pages, both sides of said front and back cover pages, and one side of the other of said at least two center pages, and said at least one internal binding sheet being attached to the opposite sides of said at least two center pages.

4. The book of claim 1 wherein said at least one binding sheet includes at least an external binding sheet and at least one internal binding sheet, and wherein said at least one center page includes at least two center pages, said external binding sheet being attached to at least a portion of one side of said front and back cover pages and wrapping around to the other side of said front and back cover pages, at least one internal binding sheet being attached to one side of the front cover page and one side of one of said at least two center pages, another internal binding sheet being attached to respective sides of said at least two center pages, and another internal binding sheet being attached to one side of the back cover page and one side of the other of said at least two center pages.

5. The book of claim 1 wherein said at least one binding sheet includes at least an external binding sheet and at least one internal binding sheet, and wherein said at least one center page includes at least two center pages, said external binding sheet being attached to at least a portion of the front and back cover pages, at least one internal binding sheet being attached to one side of the front cover page and one side of one of said at least two center pages, another internal binding sheet being attached to respective sides of said at least two center pages, and another internal binding sheet being attached to one side of the back cover page and one side of the other of said at least two center pages.

6. The book of claim 1 including an interior book having at least a front page and a back page, said at least one center page having a recess associated therewith sized and shaped for removably receiving said interior book, said book being adapted to fully open and close when said interior book is removably inserted within said recess.

7. The book of claim 4 wherein at least one of said two center pages includes a recess, an interior book sized and shaped for being removably inserted within said center page recess, said interior book including at least a front page and a back page, said book being adapted to fully open and close when said interior book is inserted within said center page recess.

8. The book of claim 7 wherein said interior book and said recess are similarly shaped.

9. The book of claim 7 wherein said recess extends partially through said at least one center page.

10. The book of claim 7 wherein said recess extends entirely through said at least one center page but does not extend through said internal binding sheet.

11. A book comprising:
a front cover page having opposed sides and constructed of a non-foam material;
a back cover page having opposed sides and constructed of a non-foam material;
a plurality of center pages each having opposed sides and each constructed substantially of a foam material;
at least one external binding sheet and a plurality of internal binding sheets;
said at least one external binding sheet being attached to at least a portion of one side of said front and back cover pages, an internal binding sheet residing between each center page and an adjacent center page and being attached to portions of the respective sides thereof, another internal binding sheet being attached to at least a portion of one side of the front cover page and at least a portion of one side of a first center page positioned adjacent thereto, and an additional internal binding sheet being attached to at least a portion of one side of the back cover page and at least a portion of one side of a last center page positioned adjacent thereto.

12. The book of claim 11 wherein said at least one external binding sheet is attached to at least a portion of one side of said front and back cover pages and wrapping around to the other side of said front and back cover pages, an internal binding sheet residing between each center page and an adjacent center page and being attached to at least portions of the respective sides thereof, another internal binding sheet being attached to at least a portion of one side of the front cover page and at least a portion of one side of a first center page positioned adjacent thereto, and an additional internal binding sheet being attached to at least a portion of one side of the back cover page and at least a portion of one side of a last center page positioned adjacent thereto.

13. The book of claim 11 wherein said external binding sheet is attached to at least a portion of one side of said first of said center pages, both sides of said front and back cover pages, and at least a portion of one side of said last of said center pages, and an internal binding sheet residing between each center page and an adjacent center page and being attached to at least portions of the respective sides thereof.

14. The book of claim 11 wherein at least one of said plurality of center pages includes at least one opening, at least one interior book being sized and shaped for removable insertion within said at least one center page opening, said interior book including at least a front page and a back page, said book being adapted to fully open and close when said at least one interior book is removably inserted into said at least one center page opening.

15. The book of claim 11 wherein at least one of said plurality of center pages includes an opening associated with each opposite side thereof, a pair of interior books, each interior book being sized and shaped for being removably retained within a respective one of said center page openings, each of said interior books including at least a front page and a back page, said book being adapted to fully open and close when said pair of interior books are inserted within said respective center page openings.

16. The book of claim 11 wherein at least two facing sides of adjacent center pages each include an opening, a pair of interior books, each interior book being sized and shaped for being removably retained within a respective one of said center page openings, each said interior book including at least a front page and a back page, said book being adapted to fully open and close when said interior books are inserted within said center page openings.

17. The book of claim 14 wherein said at least one interior book and said at least one opening are similarly shaped.

18. The book of claim 14 wherein said at least one opening extends partially through said at least one of said plurality of center pages.

19. The book of claim 11 including an opening extending through said front cover page, said back cover page, and said plurality of center pages, said opening forming a handle for carrying said book.

20. The book of claim 14 wherein said front cover page includes an opening extending therethrough, said front cover page opening providing visual access to at least a portion of said at least one interior book.

21. The book of claim 12 wherein said front and back cover pages each include a respective rear edge portion, said at least one external binding sheet being attached to the respective rear edge portions of said front and back cover pages.

22. The book of claim 12 wherein said plurality of center pages each include a respective rear edge portion, said at least one external binding sheet being attached to the respective rear edge portions of said plurality of center pages.

23. A book comprising:
a front cover page having opposed sides and constructed of a non-foam material;
a back cover page having opposed sides and constructed of a non-foam material;
a plurality of center pages each having opposed sides and each constructed substantially of a foam material;
at least one external binding sheet and a plurality of internal binding sheets;
said at least one external binding sheet being attached to at least a portion of both sides of said front and back cover pages and at least a portion of one side of a first center page and at least a portion of one side of a last center page, and an internal binding sheet residing between each center page and an adjacent center page and being attached to at least portions of the respective side thereof;
said binding sheets connecting the front and back cover pages and the plurality of center pages in book format.

24. The book of claim 23 wherein at least one of said plurality of center pages includes a cut-out, an interior book sized and shaped for removable insertion within said center page cut-out, said interior book including at least a front page and a back page, said book being adapted to fully open and close when said interior book is removably inserted within said cut-out.

25. The book of claim 23 wherein said front and back cover pages each include a respective rear edge portion, said at least one external binding sheet being attached to the respective rear edge portion of said front and back cover pages

26. The book of claim 23 wherein said plurality of center pages each include a respective rear edge portion, said at least one external binding sheet being attached to the respective rear edge portions of said plurality of center pages.

27. A book comprising:
a front cover page having opposed sides and constructed of a non-foam material;
a back cover page having opposed sides and constructed of a non-foam material;
at least one center page having opposed sides and constructed substantially of a foam material;
at least one binding sheet, said at least one binding sheet forming said front and back cover pages and binding said at least one center page in book format.

28. The book of claim 27 wherein said at least one binding sheet is attached to both sides of said at least one center page.

29. The book of claim 27 wherein said at least one binding sheet includes an external binding sheet and at least one internal binding sheet, and wherein said at least one center page includes at least two center pages, said external binding sheet forming said front and back cover pages and being attached to one side of each of said two center pages, and said at least one internal binding sheet being attached to the opposite sides of said at least two center pages.

30. The book of claim 27 wherein said at least one binding sheet includes an external binding sheet and a plurality of internal binding sheet, and wherein said at least one center page includes at least two center pages, said external binding sheet forming said front and back cover pages, at least one internal binding sheet being attached to one side of the front cover page and one side of one of said at least two center pages, another internal binding sheet being attached to respective sides of said at least two center pages, and another internal binding sheet being attached to one side of the back cover page and one side of the other of said at least two center pages.

31. The book of claim 27 wherein said at least one center page includes a recess adapted for containing an interior book, and an interior book adapted for removable insertion within said center page recess, said interior book including at least a front page and a back page, said book being adapted to fully open and close when said interior book is removably inserted into said recess.

32. A book comprising:
a front cover page;
a back cover page;
at least one center page having opposed sides;
said front and back cover pages and said at least one center page being bound in book format;
said at least one center page having a recess associated with one side thereof; and
an interior book adapted for removable insertion within said recess, said interior book including at least a front page and a back page;
said book being adapted to fully open and close when said interior book is removably inserted into said recess.

33. The book of claim 32 wherein said at least one center page includes an additional recess associated with the opposite side thereof, and an additional interior book adapted for removably insertion within said additional recess, said additional interior book including at least a front page and a back page;
said book being adapted to fully open and close when said additional interior book is removably inserted within said additional recess.
